(19) United States
(12) Patent Application Publication
(10) Pub. No.: US 2010/0079443 A1
(43) Pub. Date: Apr. 1, 2010

(54) APPARATUS, SHIFT REGISTER UNIT, LIQUID CRYSTAL DISPLAY DEVICE AND METHOD FOR ELIMINATING AFTERIMAGE

(75) Inventors: Lee-Hsun Chang, Hsin-Chu City (TW); Chiu-Mei Yu, Hsin-Chu City (TW); Wen-Pin Chen, Hsin-Chu City (TW); Je-Hao Hsu, Hsin-Chu City (TW)

Correspondence Address: AUSTIN RAPP & HARDMAN, 170 South Main Street, Suite 735, SALT LAKE CITY, UT, 84101, US

(73) Assignee: AU Optronics Corp., Hsin-Chu (TW)

(21) Appl. No.: 12/552,249

(22) Filed: Sep. 1, 2009

(30) Foreign Application Priority Data
Sep. 26, 2008 (TW) 097137278

(51) Int. Cl. G09G 5/00; G09G 3/36

(52) U.S. Cl. 345/214; 345/98

(57) ABSTRACT

An apparatus, a shifter register unit, a liquid crystal display device and a method for eliminating afterimage are provided herein, which merely utilize a high voltage source delay discharging phenomenon oriented from a powered-off power device to lead any two of a plurality of existing signal sources employed by the shift register unit to reach a high level used for controlling of charge and discharge of a discharge switching unit corresponding to a pixel unit. Therefore, a power-off afterimage problem could be improved and a signal reset function for power-on also can be achieved.

### CLAIM OF PRIORITY

This application claims priority to Taiwanese Patent Application No. 097137278 filed on Sep. 26, 2008.

### BACKGROUND OF THE INVENTION

1. Field of the Invention

The present invention relates to an apparatus, a shifter register unit, a liquid crystal display device and a method for eliminating afterimage, and more particularly, to a shift register unit used for eliminating a power-off afterimage of a liquid crystal display device.

2. Description of the Prior Art

Conventional liquid crystal display (LCD) commonly utilizes a set of driving circuits to control gray signal outputs of a plurality of pixel units allocated over a panel of the LCD. The driving circuits primarily include a gate driver electrically connected with transverse scan lines (or gate lines) each for outputting a gate pulse signal to its corresponding pixel unit, and a source driver electrically connected with longitudinal data lines (or source lines) each for transmitting a data signal to its corresponding pixel unit. Each of the intersections between the scan lines and data lines is electrically connected with two polar terminals of an active component (such as a thin film transistor having a gate and a source) corresponding to the pixel unit.

Presently, the conventional LCD (LCD) panel such as some adopts a Low Temperature Poly-Silicon (LTPS) process which relocates a shift register on a glass substrate from the existing gate driver chip to constitute cascaded multi-stage shift register modules as implementing “Gate on Array (GOA)”. At the same time when a gate driver of each stage of such shift register modules outputs gate pulse signals in turn via the scan line to turn on a corresponding transistor connected with the scan line, a source driver outputs corresponding data signals via the data line to charge at least one storage capacitor (C_{S}) and liquid crystal capacitor (Clc) connected with the data line to reach a required pixel potential so as to display various gray levels. Nevertheless, with involvement of the charge, the liquid crystal capacitor (Clc) between both polar terminals (such as common and displaying polarities) preserves a specific pixel potential by accumulating electric charges thereon after the conventional LCD displays image for a long time. It invokes retardation of afterimage elimination from a frame of the conventional LCD for a while after a system power of the conventional LCD is powered off. If the conventional LCD progressively accomplishes discharge of the pixel potential by the only way of current leakage on the transistor of each corresponding pixel, the power-off afterimage phenomenon therefore would continue for a long time.

For eliminating the power-off afterimage phenomenon, it is essential to simultaneously pull up output level of each of the gate lines to be higher than a maximum pixel potential for an instant after power off of the system, whereby the accumulated electric charges stored within the liquid crystal capacity can be rapidly released. There are so many conventional methods to simultaneously pull up output level of each of the gate lines in an instant, one of which is to utilizes a gate driver circuit integrated on array (GOA) with employments of two different clock signals (i.e. CLK1 and CLK2) on respectively providing gate pulse signal outputs for odd stage and even stage shift registers. The gate pulse signals output in turns from a first stage to the last stage shift registers. By the different clock signals (CLK1), (CLK2) and a low voltage source (Vss) outputted from an improved power control circuit, during an instant after power off of the system, the different clock signals (CLK1), (CLK2) and the low voltage source (Vss) can be simultaneously pulled up to a higher voltage level (e.g. Vdd) to bring the gate pulse signal output of each of the gate lines to a higher level, whereby the accumulated electric charges stored within the liquid crystal capacity can be rapidly discharged; the other of which is to utilizes a conventional gate driver circuit integrated on array (GOA) unit 2 as shown in FIG. 1A, similar to the structure of the above-mentioned GOA, including multiple stages gate driver circuits 22 each such as a shift register connected to a first end of each gate line 4 and generating the gate pulse signal output in turns to a gate of a corresponding transistor (T_{MIN}) on each of the intersections between the gate lines 4 and data lines 5. Compared with the above-mentioned GOA, the differences are that a second end of each gate line 4 is connected to a XON circuit 9 which includes a level shifter 10 and multiple charge/discharge circuits 11.

As shown in FIGS. 1A and 1B, during a period of powering on the whole system, the level shifter 10 outputs a low level V_{g1} depending on a XON input signal level to disable each of multiple charge/discharge circuits 11 from charging/discharging the corresponding gate line 4. Oppositely, in the instant when the whole system is powered off, the level shifter 10 changes to output a high level V_{gh} depending on different XON input signal level so as to enable each of multiple charge/discharge circuits 11 to charge the corresponding gate lines 4 to reach a high potential. Then the high potential is gradually discharged to a ground level (GND) as a waveform ‘Gn’ shown in FIG. 1B, whereby the electric charges stored within the storage capacitor (C_{S}) can be released sufficient to improve the power-off afterimage phenomenon. Nevertheless, the conventional gate driver circuit design has higher element cost and complexity due to usage of an additional XON circuit 9 and XON signal input for control of charging/discharging the pixels.

### BRIEF SUMMARY OF THE INVENTION

One object of the present invention is to provide an apparatus, a shifter register unit, a liquid crystal display device and a method for eliminating afterimage, which merely utilize any two of a plurality of existing signal sources including, for example, an initial setting signal (STV), a first clock signal (CKV1) and a second clock signal (CKV2), employed by the shift register unit to control the charge and discharge of a discharge switching module for a corresponding pixel unit and thereby eliminate a power-off afterimage, without establishment of an additional signal source to drive the discharge switching module and usage of an extra level shifter within the gate driver circuit unit. Accordingly, the present invention is capable to reduce element cost and system complexity.

To accomplish the above invention object, the present invention provides a liquid crystal display device for eliminating afterimage, which includes a first and second substrates, a plurality of pixel units, at least one signal control unit, a shift register unit and an eliminating-afterimage apparatus. The signal control unit having a power control unit and a level shifter, provides a first signal and a second signal to both the shift register unit and the eliminating-afterimage apparatus. The signal control unit simultaneously outputs the first and second signals both with high levels when receiving a power input signal with waveform transiting into a falling edge, wherein the first signal is treated as an initial setting signal and the second signal is treated as one of a first clock signal and a second clock signal both which have inverse phases with each other. As long as the power input signal and initial setting signal both are at high level, the first and second signals are at low level. In other embodiment, the first signal is treated as one of the first and second signals and the second signal is treated as the initial setting signal.

The shift register unit connected with various of signal sources from the signal control unit, has multiple stages shift registers each including at least one pull-up driving module, a pull-up module and at least one pull-down control module, wherein the pull-up module connected with the pull-up driving module, has a gate signal output terminal for outputting a gate signal according to one of the first and second signals to the corresponding pixel unit.

The eliminating-afterimage apparatus is constituted with either one or more than one discharge switching module disposed the outside or inside of the shift register. In one of the embodiments, the discharge switching module can be implemented as a thin film transistor (TFT) and has a gate connected to the first signal, a source connected to the second signal and a drain connected to both the pull-up module and gate signal output terminal of the shift register. At least one single-cross-section trace is formed from a corresponding contact pad to the discharge switching module for transmitting the first or second signal generated by the signal control unit therebetween. Perfectly, the single-cross-section trace is made of a single kind of metal. The discharge switching module (as by a gate of the TFT) is electrically connected with both the high-level second signal and the gate signal output terminal of the shift register. The discharge switching module (through a gate of the TFT) charges/discharges to the corresponding pixel unit as long as enabled/triggered by the high-level second signal and thereby eliminates the power-off afterimage.

Besides, the present invention also provides a method for eliminating afterimage, applied with a liquid crystal display device having a signal control unit and at least one shift register, and comprises the following steps of:
in a instant when the liquid crystal display device is powered off, the signal control unit simultaneously providing a high-level first and second signals, one of which is used to initialize the at least one shift register; and
enabling a discharge switching module by the high-level first signal to electrically connect the high-level second signal with a gate signal output terminal of the at least one shift register and thereby discharging for at least one corresponding pixel unit located in the liquid crystal display device so as to eliminate a power-off afterimage, wherein the first and second signals is gradually discharged from the high level to a low level.

The advantages and novel features of the invention will become more apparent from the following detailed description of a preferred embodiment when taken in conjunction with the accompanying drawings.

### BRIEF DESCRIPTION OF THE DRAWINGS

The present invention may best be understood through the following description with reference to the accompanying drawings, in which:

FIG. 1A illustrates a schematic circuitry diagram of a conventional gate driver circuit integrated on array (GOA) unit;

FIG. 1B depicts waveform variances of several signals used with the conventional gate driver circuit integrated on array (GOA) unit as shown in

FIG. 1A;

FIG. 2A illustrates an architectural block diagram of a liquid crystal display device according to a first preferred embodiment of the present invention;

FIG. 2B illustrates a schematic circuitry diagram of a shift register unit according to the first preferred embodiment of the present invention;

FIG. 2C illustrates a schematic circuitry diagram of one of shift registers of the shift register unit according to the first preferred embodiment of the present invention;

FIG. 2D depicts waveform variances of several signals used with the shift register unit according to the first preferred embodiment of the present invention;

FIG. 3 illustrates a schematic structural diagram of a discharge switching module according to the first preferred embodiment of the present invention;

FIG. 4A illustrates a schematic circuitry diagram of a shift register of a shift register unit according to a second preferred embodiment of the present invention;

FIG. 4B depicts waveform variances of several signals used with the shift register unit according to the second preferred embodiment of the present invention;

FIG. 5A depicts waveform variances of emulated different clock signals used with the shift register unit according to the first preferred embodiment of the present invention;

FIG. 5B depicts waveform variances of emulated pixel potentials with respect to different-size TFTs, according to the first preferred embodiment of the present invention; and

FIG. 5C depicts waveform variances of gate pulse signals emulated with respect to different-size TFTs, according to the first preferred embodiment of the present invention.

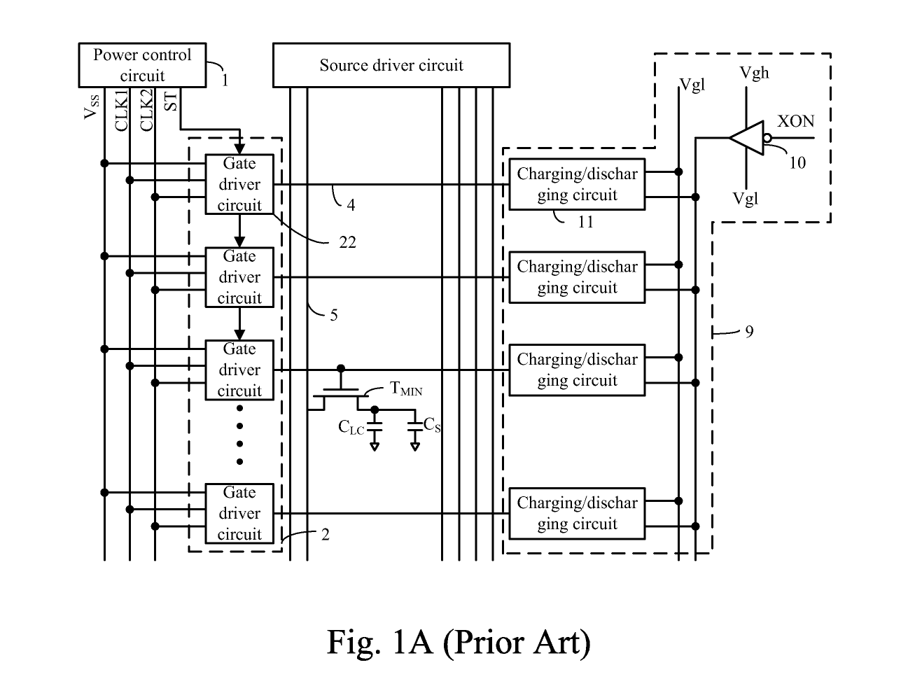

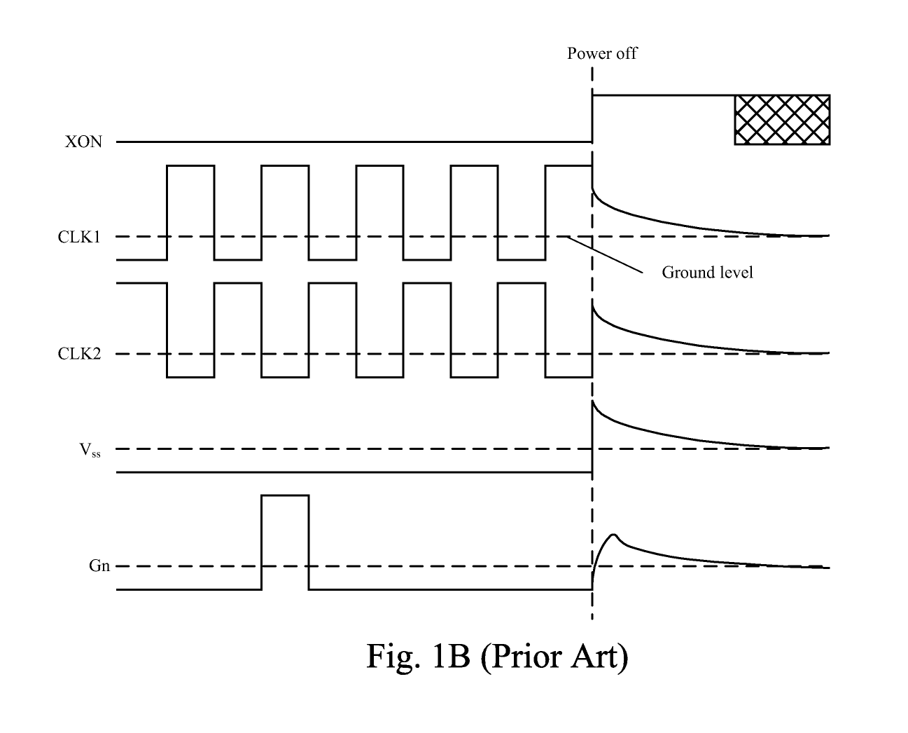

### DETAILED DESCRIPTION OF THE INVENTION

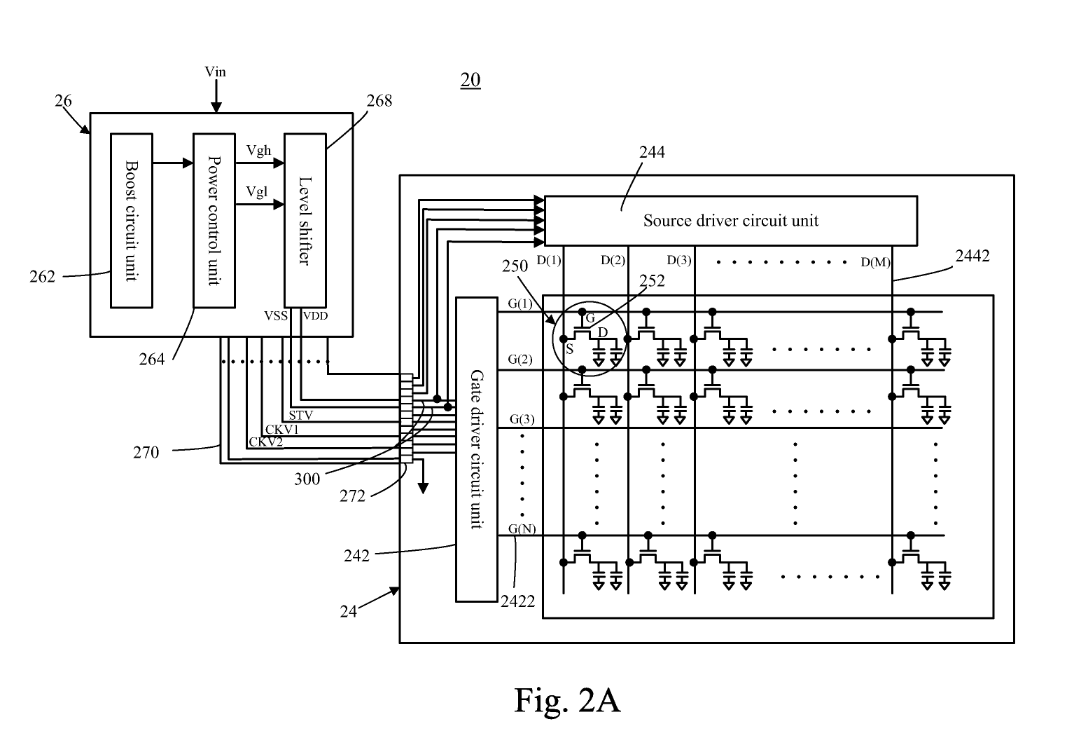

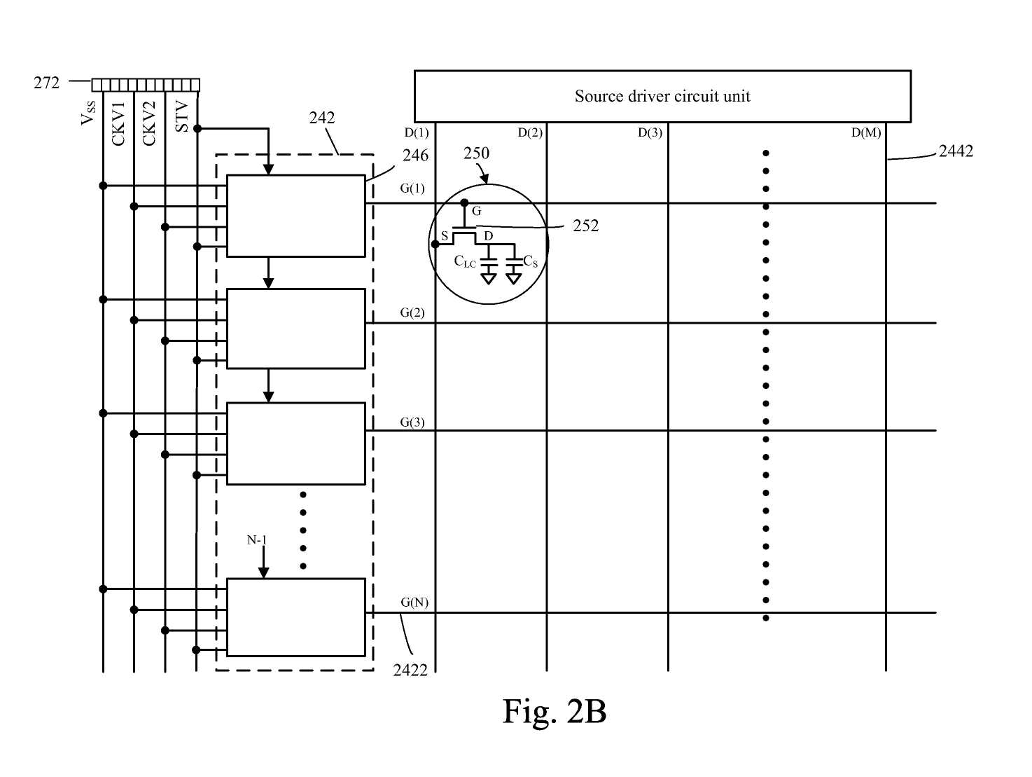

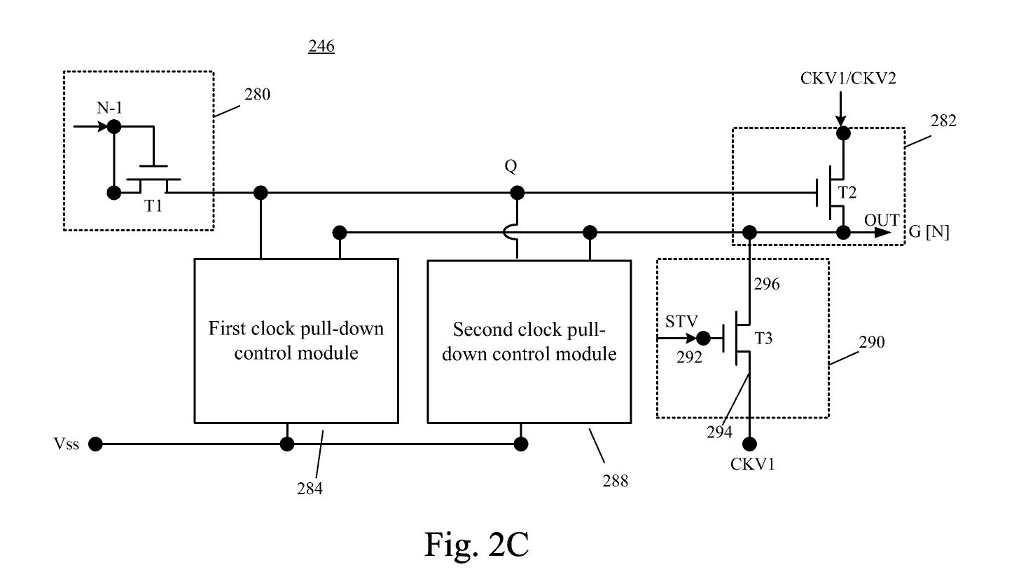

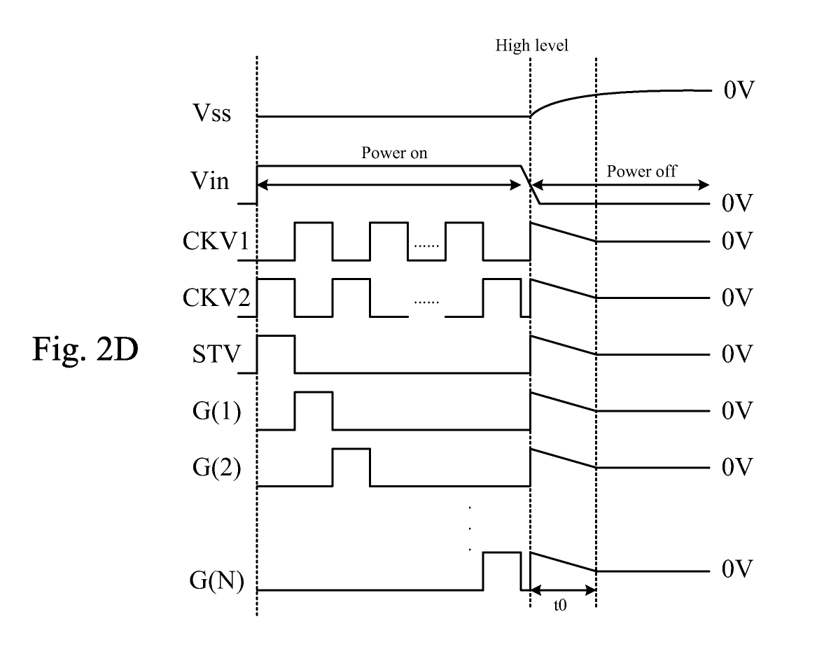

Firstly referring to illustration of FIGS. 2A and 2B, a liquid crystal display device 20 for eliminating afterimage, according to a first preferred embodiment of the present invention, which includes an first substrate (not shown), a second substrate such as an array substrate 24 and liquid crystal (LC) molecules sealed between the first and second substrates. The array substrate 24 is disposed with a gate driver circuit unit 242 and a source driver circuit unit 244. In this embodiment as shown in FIG. 2B, the gate driver circuit unit 242 is implemented with a shift register unit having a plurality of odd-stage shift registers 246 and a plurality of even-stage shift registers 246. These even-stage and odd-even shift registers 246 are used to output their gate pulse signals (G(1)˜G(N)) in turns via a plurality of corresponding gate lines (or scan lines) 2422 to trigger gates (G) of corresponding thin film transistors (TFTS) 252 disposed on matrix pixel units 250 so that a storage capacity (Cₛ) and a liquid crystal capacity (C_{1c}) both connected to a drain (D) of each of the corresponding TFTS 252 are charged/discharged with the gray data transmitted from the source driver circuit unit 244 to sources (S) of the corresponding TFTS 252 via a plurality of data lines (D(1)˜D(N)). Actually, during a period when the liquid crystal display device 20 is powered on, an electric field is established between the first and second substrates to form the liquid crystal capacity (C_{1c}) with respect to the pixel units 250.

In this embodiment as shown in FIGS. 2A and 2B, the liquid crystal display device 20 has a typical signal control unit 26 which is electrically connected to several contact pads 272 allocated adjacent to an edge of the array substrate 24 via a flexible printed circuit (FPC) board 279 and thereby transmits various of signal sources to the array substrate 24. The typical signal control unit 26 can be commonly-used element in the field and includes a boost circuit unit 262, a power control unit 264 such as a PWM IC and a level shifter 268. By the boost circuit unit 262 which is principally consisted of at least one large-size capacity and inductance, levels of a high voltage source (V_{gh}) and a low voltage source (V_{g1}) generated from the power control unit 264 can be raised in an instant. Because the large-size capacity can be charged based on a power-on condition of a system power, and otherwise discharges to output a level near the high voltage source (V_{gh}) in the instant when the system power is cut off or powered off. According to the high voltage source (V_{gh}) and the low voltage source (V_{g1}), the level shifter 268 generates a level-shifted high voltage source (V_{DD}) and a level-shifted low voltage source (Vₛₛ) to the corresponding shift registers 246, as references for output levels of gate pulse signals (G(1)˜G(N)) from the shift registers 246. Since the power control unit 264 receives a power input signal (Vin), level variances of signal sources outputted from the power control unit 264 all depend on the power input signal (Vin). For example, if the power control unit 264 of the signal control unit 26 receives a power input signal (Vin) with a waveform transiting into a falling edge in the instant when the system power is cut off, the boost circuit unit 262 discharge to output a high level near the high voltage source (V_{gh}) and then gradually falls in level, as bringing a high voltage source (V_{gh}) delay discharging phenomenon. In the same instant with effect of the high voltage source (V_{gh}) delay discharging phenomenon, most of signal sources provided from the signal control unit 26, including an initial setting signal (STV), a first clock signal (CKV1) and a second clock signal (CKV2) (as various signal waveforms shown in FIG. 2D), occur in high levels for use of each stage shift register 246 of the gate driver circuit unit 242 of the array substrate 24, except that the level-shifted low voltage source (Vₛₛ) gradually rises to 0 V.

As shown in FIGS. 2A, 2B and 2C, each stage shift register 246 of the gate driver circuit unit 242 of the array substrate 24 has a gate signal output terminal (OUT) which is used to output the gate pulse signal (G(1)˜G(N)) for TFTS 252 of the corresponding pixel unit 250, and can be controlled to electrically connect the several signal sources, including the initial setting signal (STV), the first clock signal (CKV1), the second clock signal (CKV2) and the level-shifted low voltage source (Vₛₛ), transmitted via traces of contact pads 272 of the array substrate 24, wherein the first and second clock signals (CKV1), (CKV2) have inverse phases with each other and different signal connections depending upon different even or odd stage shift shifters 246. In this embodiment, except that the first stage shift register 246 outputs its gate pulse signal G(1) based on receiving the initial setting signal (STV), other ‘Nth’ stage shift registers 246 outputs their gate pulse signal G(N) based on driving of a setting signal (N−1) outputted from a previous or ‘(N−1) th’ stage shift registers 246. This is included in but does not limit the claimed scope of the present invention with other type signal connections.

Please further refer to FIG. 2C, which illustrates a schematic internal circuitry diagram of each stage shift register 246 in the shift register unit 242 according to the first preferred embodiment of the present invention. The shift register 246 includes at least one pull-up driving module 280, a pull-up module 282, a first clock pull-down control module 284, a second clock pull-down control module 288 and an apparatus 290 for eliminating afterimage, wherein the pull-up driving module 280 includes a first transistor (T1) having a drain and a gate both connected with the initial setting signal (STV) or the setting signal (N−1) outputted from the previous stage shift registers 246, and a source connected with an input node (Q) and thereby generating a driving signal thereon. In other embodiment, the apparatus 290 can be disposed out of the shift register 246.

The pull-up module 282 includes a second transistor (T2) having a gate connected with the input node (Q) and trigged by way of receiving the driving signal of the pull-up driving module 280, a drain connected with either the first or second clock signals (CKV1), (CKV2) based on the odd or even stage shift register 246 to which the pull-up module 282 belongs, and a source connected to the gate signal output terminal (OUT).

The first and second clock pull-down control modules 284, 288 respectively are electrically connected with the gate signal output terminal (OUT), at least one of which includes a pull-down driving module and a pull-down module (not shown). After the shift register 246 outputs a gate pulse signal G(N), the first and second clock pull-down control modules 284, 288 are electrically connected with the low voltage source (Vₛₛ) to pull down levels of the first and second clock signals (CKV1), (CKV2).

As shown in FIG. 2C, the eliminating-afterimage apparatus 290 according to the first prefer embodiment of the present invention, includes at least one discharge switching module (or more one) as implemented in a thin film transistor, which is represented by a third transistor (T3), having a gate 292 electrically connected with the initial setting signal (STV), a source 294 electrically connected with the first clock signal (CKV1) and a drain 296 electrically connected with both the gate signal output terminal (OUT) and the source of the second transistor (T2) of pull-up module 282.

As shown in FIGS. 2A, 2C and 2D, when the power control unit 264 of the signal control unit 26 receives a high-level power input signal (Vin), it means that the related system power is on a power-on condition. Oppositely, in an instant when the power control unit 264 receives the power input signal (Vin) with waveform transiting into an falling edge, it means that the related system power is cut off or powered off. By discharge of capacity within the boost circuit unit 262 with response to power off of the system power, a delay discharge time (t0) is probably established on a period that a waveform of the high voltage source (V_{gh}) outputted from the power control unit 264 is initially raised to high level in the power-off instant, and then gradually falls downward. As shown in FIG. 2D, during the delay discharge time (t0) under involvement of the high voltage source (V_{gh}) delay discharging phenomenon, most of signal sources provided from the signal control unit 26, including the initial setting signal (STV), the first clock signal (CKV1) and the second clock signal (CKV2), occur in high levels in the same instant and then discharge to gradually fall downward to 0V, except that the level-shifted low voltage source (Vₛₛ) is not involved with delay discharging phenomenon and gradually rises to 0 V. During the delay discharge time (t0) from high levels to 0V of the initial setting signal (STV), the first clock signal (CKV1) and the second clock signal (CKV2), initially the gate 292 of the third transistor (T3) of each stage shift registers 246 (as shown in FIG. 2C) is triggered by the high-level initial setting signal (STV) to electrically connect the high-level of the first clock signal (CKV1) with the gate signal output terminal (OUT) so that each stage shift register 246 can simultaneously output high-level gate pulse signal (G(1)˜G(N)), and then gradually fall to 0V, as the same as charging and discharging for each of the corresponding pixel units 250 so as to release electric charges stored within liquid crystal capacity (C_{1c}) and therefore lower its pixel potential. It notes that according to the present invention, during a normal operation period when the system power is powered on (i.e. the power input signal (Vin) occurs in a high level), even if the first clock signal (CKV1) connected with the source 294 of the discharge switching module (i.e. the third transistor (T3)) occurs in a high level, the gate 292 of the third transistor (T3) can not be triggered by the low-level initial setting signal (STV) to obstruct the normal operation of each stage shift register 246. In other embodiment, the apparatus 290 can be disposed out of each stage shift register 246 and retains desired electrical connections with each stage shift register 246 and several signal sources of the signal control unit 26. In other embodiment, there is a change that the third transistor (T3) has a gate 292 connected to the first clock signal (CKV1) and a source 294 connected to the initial setting signal (STV), other than the first embodiment that the gate 292 of the third transistor (T3) is connected to the initial setting signal (STV) can achieve a better system reliability.

As long as the system power is powered on or restarts (i.e. the power input signal (Vin) transits into a high level), by the high-level initial setting signal (STV) but the first clock signal (CKV1) occurring in a low level and connected with the source 294 of the third transistor (T3) (i.e. the discharge switching module), the gate pulse signal (G(1)˜G(N)) outputted from each stage shift register 246 is pulled down simultaneously to low level, as the same as resetting the output signal of each stage shift register 246. Hence, the present invention can also provide a resetting-signal function upon the power on of the system power.

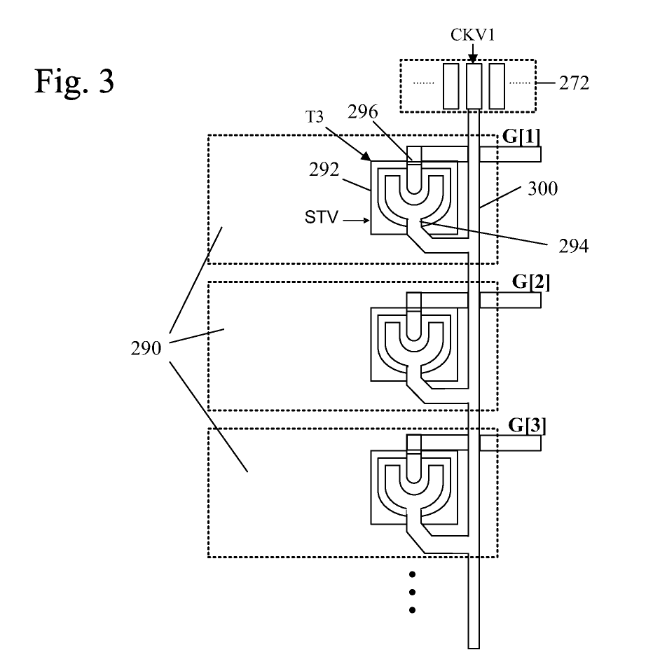

Besides as shown in FIGS. 2A and 3, to prevent through holes formed on the array substrate 24 from being burned by instant larger currents of the power off, at least one trace 300 made of single kind of metal establishes a direct connection from the corresponding contact pad 272 to the discharge switching module (i.e. the source 294 of the third transistor (T3)) of the apparatus 290 of each stage shift register 246 and is used to transmit the first or second clock signal (CKV1) or (CKV2) generated by the signal control unit 26 therebetween. Perfectly, the trace 300 has single cross section and is not formed with a through-hole structure connected to other elements.

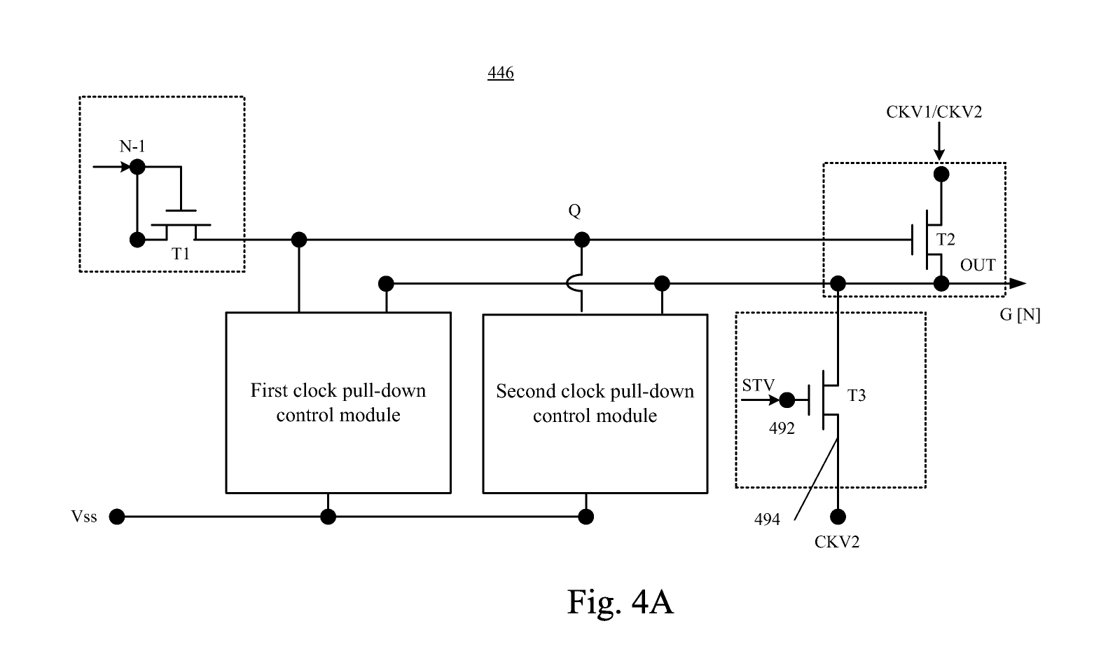

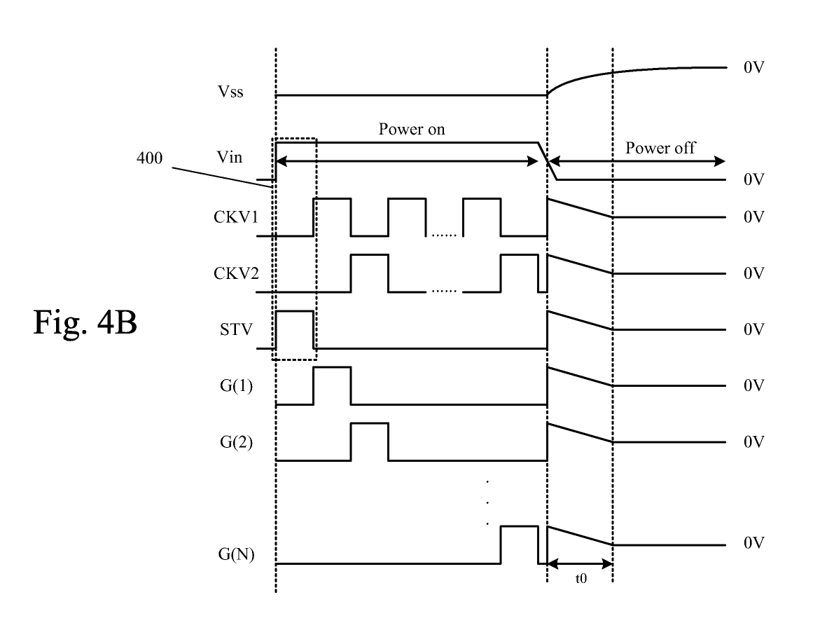

Please further refer to FIG. 4A, which illustrates a schematic internal circuitry diagram of each stage shift register 446 according to a second preferred embodiment of the present invention. A difference from said first embodiment is that a source 494 of third transistor (T3) of the shift register 446 of the second embodiment is changed to be connected with the second clock signal (CKV2). The rest signal connection, for example, the connection between gate 492 and the initial setting signal (STV), is kept unchanged. Due to different signal connection of the source 494 from said first embodiment, as marked by a block 400 in FIG. 4B, during a period when the power input signal (Vin) and initial setting signal (STV) both occur in high levels, the second clock signal (CKV2) is set at a low level to obtain the resetting-signal function upon the power on of the system. The rest of the signal waveforms can be referred to the same as depicted in FIG. 2D and will not be detailed herein.

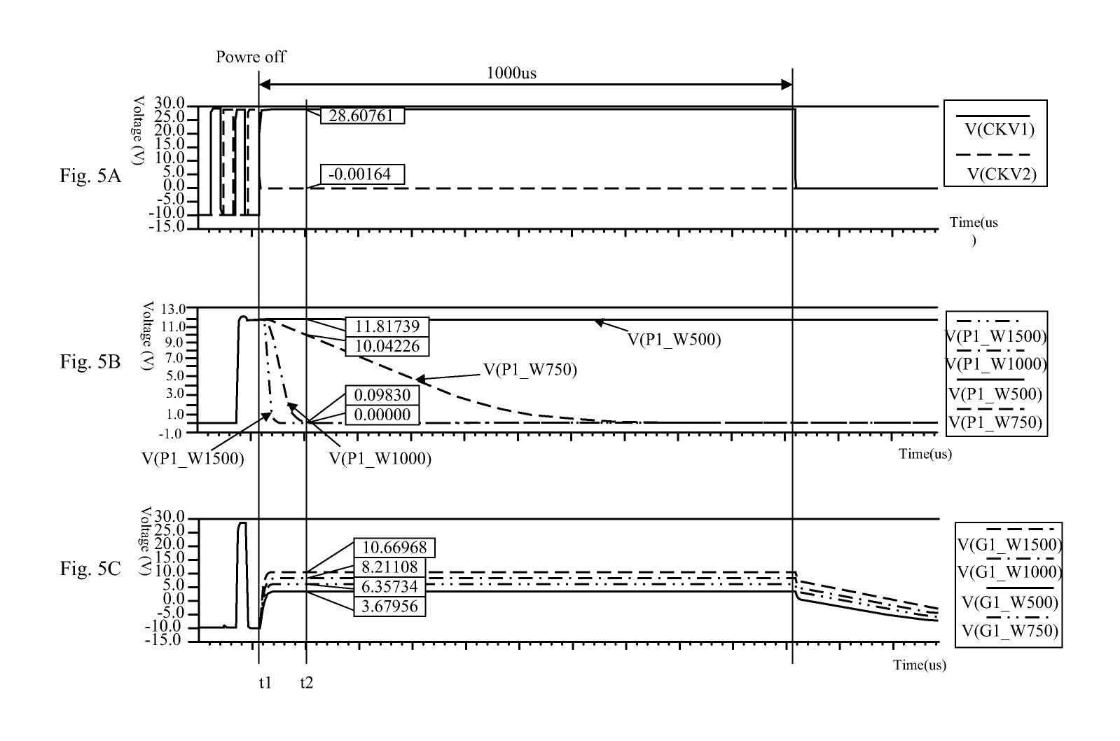

Further referring to FIG. 5A, waveform variances of emulated first and second clock signals ‘V(CKV1)’, ‘V(CKV2)’ used for the shift register unit according to the first preferred embodiment of the present invention is introduced. By such an emulation, in an instant (t1) when the system power is powered off, the first clock signal ‘V(CKV1)’ and the second clock signal ‘V(CKV2)’ both rise upward to a high level of approximate 28.60761V. During a measured period of 1000 us after the instant (t1), the first clock signal ‘V(CKV1)’ is found remaining in a square wave with the high level of approximate 28.60761V by a sampling time (t2). Then the first clock signal ‘V(CKV1)’ falls near a low level of approximate −0.00164V.

FIG. 5B depicts waveform variances of emulated pixel potentials with respect to different-size transistors (i.e. TFTS) according to the first preferred embodiment of the present invention. Using different-size transistors to be the third transistor (T3) of the shift register is measured for the signal emulation. Since a discharge performance can be determined depending on a size of the transistor which is defined with a ratio (W/L) of a channel width (W) to a channel length (L) of the transistor. Commonly speaking, a larger-ratio (W/L) transistor can provide a better discharge performance due to its rapid discharge speed. In FIG. 5B, the symbolical reference ‘V(P1_W500)’ denotes a pixel potential corresponding to a small-size transistor having a ratio of ‘500/5.5’ (i.e. W=500 and L=5.5), the symbolical reference ‘V(P1_W750)’ denotes a pixel potential corresponding to a transistor having a ratio of ‘750/5.5’ (i.e. W=750 and L=5.5), the symbolical reference ‘V(P1_W1000)’ denotes a pixel potential corresponding to a transistor having a ratio of ‘1000/5.5’ (i.e. W=1000 and L=5.5), and the symbolical reference ‘V(P1_W1500)’ denotes a pixel potential corresponding to a transistor having a ratio of ‘1500/5.5’ (i.e. W=1500 and L=5.5). Referring to FIG. 5B, under driving of the same high-level of the first clock signal ‘V(CKV1)’ during the measured period of 1000 us after the instant (t1), the pixel potential ‘V(P1_W500)’ of the small-size transistor with the ratio of ‘500/5.5’ has a high level of approximate 11.81739V at the sampling time (t2), which gets the worst discharge performance than other-size transistors. At the same sampling time (t2), the pixel potential ‘V(P1_W1500)’ of the transistor with the ratio of ‘1500/5.5’ has a low level of approximate −0.0000V which gets the best discharge performance than other-size transistors. If an element-costing factor is considered beside the above discharge performance consideration, the pixel potential ‘V(P1_W750)’ of the transistor with the ratio of ‘750/5.5’ gets the most appropriate discharge performance than other-size transistors.

FIG. 5C depicts waveform variances of gate pulse signals emulated with respect to different-size thin film transistors (TFTS), according to the first preferred embodiment of the present invention. Using different-size transistors to be the third transistor (T3) of the shift register is measured for the signal emulation. In FIG. 5C, the symbolical reference ‘V(G1_W500)’ denotes a gate pulse signal corresponding to the small-size transistor having the ratio of ‘500/5.5’ (i.e. W=500 and L=5.5), the symbolical reference ‘V(G1_W750)’ denotes a gate pulse signal corresponding to the transistor having the ratio of ‘750/5.5’ (i.e. W=750 and L=5.5), the symbolical reference ‘V(G1_W1000)’ denotes a gate pulse signal corresponding to the transistor having the ratio of ‘1000/5.5’ (i.e. W=1000 and L=5.5), and the symbolical reference ‘V(G1_W1500)’ denotes a gate pulse signal corresponding to the transistor having the ratio of ‘1500/5.5’ (i.e. W=1500 and L=5.5).

Besides, a method for eliminating afterimage according to a preferred embodiment of the present invention is introduced herein, which is applied with a liquid crystal display device, as shown in FIGS. 2A-2D, having a signal control unit and multiple-stage shift registers, and the method comprises the following steps of:
in a instant when the liquid crystal display device is powered off, the signal control unit simultaneously providing a high-level first and second signals, one of which is used to initialize a first stage shift register of the multiple-stage shift registers, and the other of which is treated as either a first clock signal (CKV1) or a second clock signal (CKV2); and
enabling/triggering a discharge switching module by the high-level first signal to electrically connect the high-level second signal with a gate signal output terminal of at least one of the multiple stage shift registers and thereby discharging for at least one corresponding pixel unit located in the liquid crystal display device so as to eliminate a power-off afterimage, wherein the first and second signals is gradually discharged from the high level to a low level.

In conclusion, the apparatus, the shifter register unit, the liquid crystal display device and the method for eliminating afterimage, according to the present invention, merely utilize a high voltage source delay discharging phenomenon oriented from a power device (as a PWM IC) upon power off to lead any two of a plurality of existing signal sources employed by the shift register unit to reach a high level used for controlling the charge and discharge of a discharge switching unit to a corresponding pixel unit, wherein the existing signal sources can include but be not limited to the initial setting signal (STV), the first clock signal (CKV1) and the second clock signal (CKV2), whereby the present invention is capable of releasing electric charges accumulated in a displaying area of the liquid crystal display device in a power-off instant and thereby eliminates the power-off afterimage thereon. Therefore, the liquid crystal display device according to the present invention does not need disposal of additional signal sources for controlling the charge and discharge of the discharge switching unit, modification of ASIC used therein and usage of an extra level shifter, and thereby can reduce element cost and system complexity and achieve a resetting-signal function upon the power on.

It is to be understood, however, that even though numerous characteristics and advantages of the present invention have been set fourth in the foregoing description, together with details of the structure and function of the invention, the disclosure is illustrative only, and changes may be made in detail within the principles of the invention to the full extent indicated by the broad general meaning of the terms in which the appended claims are expressed.

What is claimed is:

1. An apparatus for eliminating afterimage, electrically connected at least one of multiple shift registers and a signal control unit disposed within a liquid crystal display device having at least one pixel unit, wherein as soon as receiving a power input signal with a waveform occurring in a falling edge, the signal control unit simultaneously provides a first signal and second signals both at high voltage level, one of which is used to initialize one of multiple shift registers, and the apparatus comprising:
at least one discharge switching module which is electrically connected with the high-level second signal and a gate signal output terminal located in the at least one of multiple shift registers, wherein the at least one discharge switching module is enabled by the high-level first signal to discharge for the at least one pixel unit.

2. The apparatus as claimed in claim 1, wherein the at least one discharge switching module is disposed within the at least one of multiple shift registers which has a pull-up module electrically connected with the at least one discharge switching module and said gate signal output terminal.

3. The apparatus as claimed in claim 2, wherein the at least one discharge switching module includes a thin film transistor having a gate connected with the first signal, a source connected with the second signal and a drain connected with the pull-up module and the gate signal output terminal of the at least one of multiple shift registers.

4. The apparatus as claimed in claim 1, wherein the first signal is an initial setting signal and the second signal is one of a first clock signal and a second clock signal.

5. The apparatus as claimed in claim 1, wherein the first signal is one of a first clock signal and a second clock signal and the second signal is an initial setting signal.

6. The apparatus as claimed in claim 4, wherein either the first signal or second signal is the first clock signal which occurs in a low voltage level with response to the power input signal and the initial setting signal both at high voltage level and has an inverse phase with the second clock signal.

7. The apparatus as claimed in claim 5, wherein either the first signal or second signal is the second clock signal which occurs in a low voltage level with response to the power input signal and the initial setting signal both at high voltage level and has an inverse phase with the first clock signal.

8. The apparatus as claimed in claim 1, wherein the signal control unit has a power control unit and a level shifter and provides a power for the multiple shift registers and the at least one discharge switching module.

9. The apparatus as claimed in claim 1, wherein the signal control unit transmits either the first signal or second signal from at least one contact pad formed on the liquid crystal display device to the at least one discharge switching module via a corresponding trace having a single cross section.

10. The apparatus as claimed in claim 9, wherein the trace is made of single kind of metal.

11. A shift register unit for eliminating afterimage, applied within a liquid crystal display device having at least one pixel unit and electrically connected a signal control unit which simultaneously provides a first signal and second signals both at high voltage level as soon as receiving a power input signal with a waveform occurring in a falling edge, and the shift register unit comprising at least one shift register comprising:
at least one pull-up driving module;
a pull-up module electrically connected with the at least one pull-up driving module and having a gate signal output terminal which outputs a gate signal to the at least one pixel unit, based on either the first signal or the second signal;
at least one pull-down control module connected with the gate signal output terminal; and
at least one discharge switching module which is electrically connected with the high-level second signal and the gate signal output terminal, wherein the at least one discharge switching module is enabled by the high-level first signal to discharge for the at least one pixel unit.

12. The shift register unit as claimed in claim 11, wherein the at least one pull-up driving module uses either the first or second signal to be an initial setting signal.

13. The shift register unit as claimed in claim 11, wherein the at least one discharge switching module has a thin film transistor having a gate connected with the first signal, a source connected with the second signal and a drain connected with the gate signal output terminal of the pull-up module.

14. The shift register unit as claimed in claim 11, wherein the at least one pull-down control module has a pull-down driving module and a pull-down module.

15. The shift register unit as claimed in claim 11, wherein the first signal is an initial setting signal and the second signal is one of a first clock signal and a second clock signal.

16. The shift register unit as claimed in claim 11, wherein the first signal is one of a first clock signal and a second clock signal, and the second signal is an initial setting signal.

17. The shift register unit as claimed in claim 16, wherein either the first signal or second signal is the first clock signal which occurs in a low voltage level with response to the power input signal and the initial setting signal both at high voltage level and has an inverse phase with the second clock signal.

18. The shift register unit as claimed in claim 15, wherein either the first signal or second signal is the second clock signal which occurs in a low voltage level with response to the power input signal and the initial setting signal both at high voltage level and has an inverse phase with the first clock signal.

19. The shift register unit as claimed in claim 11, wherein the signal control unit has a power control unit and a level shifter and provides a power for the shift register unit.

20. The shift register unit as claimed in claim 11, wherein the signal control unit transmits either the first signal or second signal from at least one contact pad formed on the liquid crystal display device to the at least one discharge switching module via a corresponding trace having a single cross section.

21. A liquid crystal display device for eliminating afterimage, comprising:
at least one pixel unit;
a signal control unit which simultaneously provides a first signal and second signals both at high voltage level as soon as receiving a power input signal with a waveform occurring in a falling edge;
at least one shift register having a gate signal output terminal which outputs a gate signal to the at least one pixel unit, based on either the first signal or the second signal; and
at least one discharge switching module which is electrically connected with the high-level second signal and the gate signal output terminal of the at least one shift register, and discharges for the at least one pixel unit by enabling of the high-level first signal.

22. A method for eliminating afterimage, applied with a liquid crystal display device having a signal control unit, at least one pixel unit and multiple shift registers, and the method comprising the following steps of:
in a instant when the liquid crystal display device is powered off, the signal control unit simultaneously providing a first and second signals both at high voltage level, one of which is used to initialize one of the multiple stage shift registers; and
enabling a discharge switching module by the high-level first signal to electrically connect the high-level second signal with a gate signal output terminal of at least one of the multiple stage shift registers and thereby discharging for the at least one pixel unit.

23. The method claimed in claim 22, further comprising the following step of the first and second signals being gradually discharged from the high voltage level to a low voltage level.
